(19) United States
(12) Patent Application Publication
(10) Pub. No.: US 2021/0081828 A1
(43) Pub. Date: Mar. 18, 2021

(54) APPLYING MONTE CARLO AND MACHINE LEARNING METHODS FOR ROBUST CONVEX OPTIMIZATION BASED PREDICTION ALGORITHMS

(71) Applicant: True Positive Technologies Holding LLC, Harrison, NY (US)

(72) Inventor: Marcos LOPEZ DE PRADO, Harrison, NY (US)

(73) Assignee: True Positive Technologies Holding LLC, Harrison, NY (US)

(21) Appl. No.: 17/016,415

(22) Filed: Sep. 10, 2020

Related U.S. Application Data
(60) Provisional application No. 62/899,163, filed on Sep. 12, 2019.

(51) Int. Cl. G06N 7/00; G06N 20/00

(52) U.S. Cl. CPC G06N 7/005; G06N 20/00

(57) ABSTRACT

Disclosed herein are methods and systems for improving accuracy of convex optimization-based prediction models while reducing their computation load by clustering a plurality of received random variables extracted from a plurality of samples to a plurality of clusters based on their covariance matrix, applying a convex optimization based prediction model to compute predicted optimal intra-cluster solutions for each cluster and an optimal inter-cluster solution over the plurality of clusters and predicting optimal solutions for the plurality of samples by based on an aggregation between the optimal intra-cluster solutions and the optimal inter-cluster solution. Separately computing the intra-cluster and the inter-cluster solution reduces the prediction model's computation load. Further disclosed are methods and systems for selecting a best performing prediction model for a certain dataset using Monte Carlo algorithms to generate simulated samples based on the received samples and computing estimation errors for the prediction models applied to the simulated samples.

### RELATED APPLICATIONS

This application claims the benefit of priority under 35 USC § 119(e) of U.S. Provisional Patent Application No. 62/899,163 filed on Sep. 12, 2019, the contents of which are incorporated herein by reference in their entirety.

### FIELD AND BACKGROUND OF THE INVENTION

The present invention, in some embodiments thereof, relates to enhancing convex optimization based prediction models and, more specifically, but not exclusively, to enhancing convex optimization based prediction models using Monte Carlo and machine learning methods.

Prediction models are widely used for a vast and diverse range of research and practical applications spanning almost any aspect of modern life ranging from physical phenomena research, through pattern and object detection to statistical and financial analysis and prediction.

Many of these applications may involve optimization problems imposed with a plurality of constraints which may often conflict with one another. For example, a financial firm may be interested in estimating allocations to a variety of investments, such that the expected return (on investment) is maximized subject to a target level of risk, or that the risk is minimized subject to a target level of expected return.

Naturally, the multitude of optionally conflicting constraints may significantly increase the complexity of the prediction models in terms of design efforts as well as computing resources and computing load involved in their runtime execution. Moreover, the optimization performance and robustness of the prediction models, for example, accuracy, reliability, consistency and/or the like under the plurality of optionally conflicting constraints may be significantly reduced.

One of the popular and commonly used methodologies, technologies and practices for addressing multiple constraints optimization problems is convex optimization, and thus convex optimization based prediction models may be applied to predict solutions for such applications involving multiple potentially conflicting constraints.

### SUMMARY OF THE INVENTION

According to a first aspect of the present invention there is provided a computer implemented method of improving the accuracy while reducing the computation load of convex optimization-based prediction models, comprising using one or more processors for:
Receiving a distribution of expected values of a plurality of random variables extracted from a plurality of samples and a covariance matrix of the plurality of random variables.
Clustering the plurality of random variables to a plurality of clusters based on the covariance matrix such that each of the plurality clusters comprising a respective subset of highly codependent expected values.
Applying a convex optimization based prediction model to compute predicted optimal intra-cluster solutions for each of the plurality of clusters.
Collapsing the covariance matrix, based on the optimal intra-cluster solutions, to a reduced covariance matrix in which each of the plurality of clusters is represented as a single variable.
Applying the convex optimization based prediction model to compute a predicted optimal inter-cluster solution over the reduced covariance matrix.
Predicting optimal solutions for the plurality of samples based on a plurality of dot products computed between the optimal intra-cluster solutions and the optimal inter-cluster solution.
Wherein splitting the prediction to separately compute the predicted optimal intra-cluster solutions and the predicted optimal inter-cluster solution reduces a computation load of the convex optimization based prediction model.

According to a second aspect of the present invention there is provided a system for reducing a computation load of convex optimization based prediction models, comprising one or more processors executing a code. The code comprising:
Code instructions to receive a distribution of expected values of a plurality of random variables extracted from a plurality of samples and a covariance matrix of the plurality of random variables.
Code instructions to cluster the plurality of random variables to a plurality of clusters based on the covariance matrix such that each of the plurality clusters comprising a respective subset of highly codependent random variables.
Code instructions to apply a convex optimization based prediction model to compute predicted optimal intra-cluster solutions for each of the plurality of clusters.
Code instructions to collapse the covariance matrix, based on the optimal intra-cluster solutions, to a reduced covariance matrix in which each of the plurality of clusters is represented as a single variable.
Code instructions to apply the convex optimization based prediction model to compute a predicted optimal inter-cluster solution over the reduced covariance matrix.
Code instructions to predict optimal solutions for the plurality of samples based on a plurality of dot products computed between the optimal intra-cluster solutions and the optimal inter-cluster solution.
Wherein splitting the prediction to separately compute the predicted optimal intra-cluster solutions and the predicted optimal inter-cluster solution reduces a computation load of the convex optimization based prediction model.

According to a third aspect of the present invention there is provided a computer program product comprising program instructions executable by a computer, which, when executed by the computer, cause the computer to perform a method according to the first aspect.

According to a fourth aspect of the present invention there is provided a computer implemented method of selecting a best performing prediction model for a certain dataset of samples, comprising:
Receiving a distribution of expected values of a plurality of random variables extracted from a plurality of samples and a covariance matrix of the plurality of random variables.
Applying a Monte Carlo algorithm which generates a plurality of simulated expected values and a plurality of simulated covariance matrices based on a user-defined Data Generating Process (DGP) characterized by the received distribution and covariance matrix.
Applying a plurality of prediction models configured to compute, based on the plurality of simulated expected values and the plurality of simulated covariance matrices, a plurality of respective predicted optimal solutions.
Computing an estimation error for each of the plurality of prediction models based on a comparison between the respective predicted optimal solution computed by the respective prediction model and a real optimal solution derived from the user-defined DGP.
Selecting a preferred prediction model whose predicted optimal solution presents a smallest estimation error. Wherein the preferred optimizations model is used to predict optimal solutions for the plurality of samples.

According to a fifth aspect of the present invention there is provided a system for selecting a best performing prediction model for a certain dataset of samples, comprising one or more processors executing a code. The code comprising:
Code instructions to receive a distribution of expected values of a plurality of random variables extracted from a plurality of samples and a covariance matrix of the same random variable.
Code instructions to apply a Monte Carlo algorithm that generates a plurality of simulated expected values and a plurality of simulated covariance matrices based on a user-defined Data Generating Process (DGP) characterized by the received distribution and covariance matrix.
Code instructions to apply a plurality of prediction models configured to compute, based on the plurality of simulated expected values and the plurality of simulated covariance matrices, a plurality of respective predicted optimal solutions.
Code instructions to compute an estimation error for each of the plurality of prediction models based on a comparison between the respective predicted optimal solution computed by the respective prediction model and a real optimal solution derived from the user-defined DGP.
Code instructions to select a preferred prediction model whose predicted optimal solution presents a smallest estimation error, wherein the preferred optimizations model is used to predict optimal solutions for the plurality of samples.

According to a sixth aspect of the present invention there is provided a computer program product comprising program instructions executable by a computer, which, when executed by the computer, cause the computer to perform a method according to the fourth aspect.

In an optional implementation form of the first, second, third, fourth, fifth and/or sixth aspects, one or more de-noising functions are applied to reduce a noise in at least some of the plurality of random variables.

In a further implementation form of the first, second, third, fourth, fifth and/or sixth aspects, one or more of the de-noising functions are based on identifying noise components and signal components in each of at least some of the plurality of random variables. The noise components and the signal components are identified by their corresponding eigenvalues computed for the received covariance matrix.

In a further implementation form of the first, second and/or third aspects, clustering the plurality of values to the plurality of clusters is done using one or more Machine Learning (ML) models applied to the covariance matrix.

In a further implementation form of the first, second and/or third aspects, the convex optimization based prediction model is applied to determine an allocation of an investment in a plurality of financial assets predicted to produce optimal outcomes.

In an optional implementation form of the fourth, fifth and/or sixth aspects, a plurality of iterations are repeated where each iterations comprises the steps of applying the Monte Carlo algorithm, and selecting a preferred prediction model whose prediction set presents the smallest estimation error. Wherein in each of the plurality of iterations the Monte Carlo algorithm generates another set of a plurality of simulated expected values and a plurality of simulated covariance matrices based on the user-defined DGP.

In a further implementation form of the fourth, fifth and/or sixth aspects, the plurality of prediction models are applied to determine an allocation of an investment in a plurality of financial assets predicted to produce optimal outcomes.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks automatically. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of methods and/or systems as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars are shown by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of an exemplary process of improving accuracy while reducing computation load of a convex optimization based prediction model, according to some embodiments of the present invention;

FIG. 2 is a schematic illustration of an exemplary system for improving accuracy while reducing computation load of a convex optimization based prediction model, according to some embodiments of the present invention;

FIG. 3A and FIG. 3B are graph charts reflecting a de-noising process applied to a distribution of eigenvalues associated with noise and signal components of a received distribution of expected values of random variables to de-noise the random variables, according to some embodiments of the present invention;

FIG. 4 is a schematic illustration of an exemplary clustering of a correlation matrix of expected values of a plurality of random variables to a limited number of clusters each comprising highly codependent expected values, according to some embodiments of the present invention;

FIG. 5 is a schematic illustration of an exemplary sequence for improving accuracy while reducing computation load of a convex optimization based prediction model, according to some embodiments of the present invention;

FIG. 6 is a flowchart of an exemplary process of selecting a best performing prediction model for a certain dataset of samples, according to some embodiments of the present invention;

FIG. 7 is a schematic illustration of an exemplary system for selecting a best performing prediction model for a certain dataset of samples, according to some embodiments of the present invention; and

FIG. 8 is a schematic illustration of an exemplary sequence for selecting a best performing prediction model for a certain dataset of samples, according to some embodiments of the present invention.

### DESCRIPTION OF SPECIFIC EMBODIMENTS OF THE INVENTION

The present invention, in some embodiments thereof, relates to enhancing convex optimization based prediction models and, more specifically, but not exclusively, to enhancing convex optimization based prediction models using Monte Carlo and machine learning methods.

Convex optimization (CVO) based prediction models may be typically applied to large datasets comprising an extremely large number of samples which need to be processed in order to compute and produce optimal solutions for each received dataset. Such large datasets may significantly increase the computing load and the computing resources (e.g. computing time, computing resources, storage resources, networking resources, etc.) consumed by the prediction models.

Moreover, changes in the random variables extracted from the input samples may significantly reduce the stability of the predicted optimal solutions computed by the prediction models thus reducing their performance, for example, accuracy, reliability, consistency and/or the like. The instability in the input variables may be traced to two main sources, noise and signal, i.e., noise in the input data and the structure of the input data itself.

According to some embodiments of the present invention, there are provided methods and systems for enhancing the convex optimization based prediction models to significantly reduce their computation load while increasing their performance and robustness. In particular, the computation load is reduced while the performance and robustness are increased by applying a Nested Clustered Optimization (NCO) for the convex optimization based prediction models.

Applying the NCO, the input random variables are clustered to a plurality of clusters each comprising a subset of highly codependent (correlated) random values. The clustering may be done using one or more trained Machine Learning (ML) models, for example, a neural network, a Support Vector Machines (SVM) and/or the like. The ML model(s) may be trained to cluster random variables to clusters in one or more supervised, semi-supervised and/or non-supervised training sessions.

Optionally, the input variables are first de-noised to reduce and potentially remove the impact of the noise to change the variables input to the convex optimization based prediction model to increase the stability of the predicted optimal solution computed by the convex optimization based prediction model. The de-noising is based, as described in detail herein after, on identifying noise components and signal components in the input data and reducing, removing and/or attenuating the noise components while leaving the signal components unaltered (unchanged).

The convex optimization based prediction model may be then applied and grained to compute a predicted intra-cluster optimal solution for each of the clusters based only on the respective subset of random variables contained in the respective cluster. Based on the predicted intra-cluster optimal solutions computed for each of the clusters, a covariance matrix of the input random variables may be reduced to produce a reduced covariance matrix in which each of the clusters is represented as a single variable. The convex optimization based prediction model may be then applied and trained to compute a predicted inter-cluster optimal solution over the reduced covariance matrix.

Final optimal solutions may be then computed based on dot products computed between the optimal intra-cluster solutions and the optimal inter-cluster solution. This may also translate to adjusting the weights of the convex optimization based prediction model according to the dot products computed between the intra-cluster weights and the inter-cluster weights.

The NCO convex optimization based prediction model may present major advantages and benefits compared to other prediction models including other CVO based prediction models.

First, some of the existing CVO based prediction models may be applied to the entire input dataset which may be typically be extremely large and executing the CVO based prediction models may thus lead to an enormous computation load. In contrast, the NCO convex optimization based prediction model splits the optimization problem to two significantly lower dimension problems which are computed separately, namely the predicted optimal intra-cluster solutions and the predicted optimal inter-cluster solution. The dimensions of the optimization problem are first reduced as the optimal intra-cluster solutions are computed over significantly small subsets of the input variables contained in the clusters. The dimensions of the optimization problem are further reduced since the predicted optimal inter-cluster solution is computed over a significantly reduced covariance matrix representing the clusters rather than the input variables where the number of clusters may be smaller by several magnitudes compared to the number of input variables. As result of the dimensions' reduction the computation load and/or the computing resources utilization of the NCO convex optimization based prediction model may be significantly reduced.

Moreover, since the subsets of input variables included in each of the clusters are independent from each other, the optimal intra-cluster solutions may be computed by the NCO convex optimization based prediction model in parallel thus further reducing the computation load, specifically the computation time.

Furthermore, by clustering the input variables to the clusters each containing a respective subset of highly correlated variables, the instability traced to the signal (variables) structure may be contained within each cluster and may not expand and/or propagate over clusters. As such, the stability of the predicted optimal solutions computed by the NCO convex optimization based prediction model may be significantly increased which in turn may significantly increase the performance and/or the robustness of the NCO convex optimization based prediction model.

In addition, some of the existing VO based prediction models may apply de-noising to the input variables with no distinction between the noise and signal components. As such, while the noise components may be reduced, the signal components may be also weakened which may lead to major instability of the predicted optimal solutions due to the very weak signal. On the other hand, applying the de-noising only to the noise components in the input variables as done by the NCO convex optimization based prediction model may significantly increase the stability of the predicted optimal solutions computed by the NCO convex optimization based prediction model since the noise, which may be a major contributor to the changes in the input variables, may be significantly removed. This in turn may further increase the performance and/or the robustness of the NCO convex optimization based prediction model.

According to some embodiments of the present invention, there are provided methods and systems for selecting a best performing prediction model from a plurality of prediction models to compute an optimal solution for a certain dataset comprising a plurality of samples. The plurality of different prediction models may optionally include the NCO convex optimization based prediction model.

In particular, the selection is based on applying the plurality of prediction models to compute predicted optimal solutions for a plurality of estimated variables generated by a Monte Carlo algorithm based on a Data Generation Process (DGP) derived from the input variables. As such the method may be designated Monte Carlo Optimization Selection (MCOS).

After the plurality of prediction models compute their respective predicted optimal solutions, an estimation error may be computed for the optimal solution computed by each of the prediction models. The prediction model which presents a smallest estimation error may be then selected to compute the predicted optimal solution for the received dataset of samples since it is expected to be the best performing prediction model for the certain dataset.

The MCOS is thus agnostic to the prediction models used to compute the optimal solution for the received dataset since the MCOS only needs the outcome, i.e., the optimal solutions produced by the prediction models to compute the estimation errors and is thus oblivious to the architecture, structure and/or internal mechanisms of the perdition models.

The MCOS may be repeated for each received dataset since it is possible and even expected that each of the prediction models may perform differently for different datasets comprising different samples.

Using a single prediction model for all received datasets as may be done by existing optimization and prediction methods and systems, for example, the existing CVO based prediction models may be highly naïve since it is most unlikely that a single prediction model may be optimal for all input datasets, i.e. for all problem scenarios, constraints, conditions, circumstances and/or the like. Applying the single prediction model may therefore essentially prevent achieving to most optimal solution for any received dataset.

In contrast, applying the MCOS to select the best performing prediction model for each received subset may enable selection of the most suitable prediction model for each received dataset thus achieving the most optimized solution for any received dataset. This is because different prediction models may perform differently for different datasets and thus selecting the prediction model estimated to most suit each received dataset may enable identifying the preferred prediction model for each received dataset which is expected to produce the most optimized solution.

Thus, rather than relying always on one particular approach, i.e., one particular prediction model the MCOS allows users to apply opportunistically whatever optimization approach and prediction model that is best suited in a particular setting (dataset).

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer program code comprising computer readable program instructions embodied on a computer readable medium may be transmitted using any appropriate medium, including but not limited to wireless, wire line, optical fiber cable, RF, etc., or any suitable combination of the foregoing.

The computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The computer readable program instructions for carrying out operations of the present invention may be written in any combination of one or more programming languages, such as, for example, assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

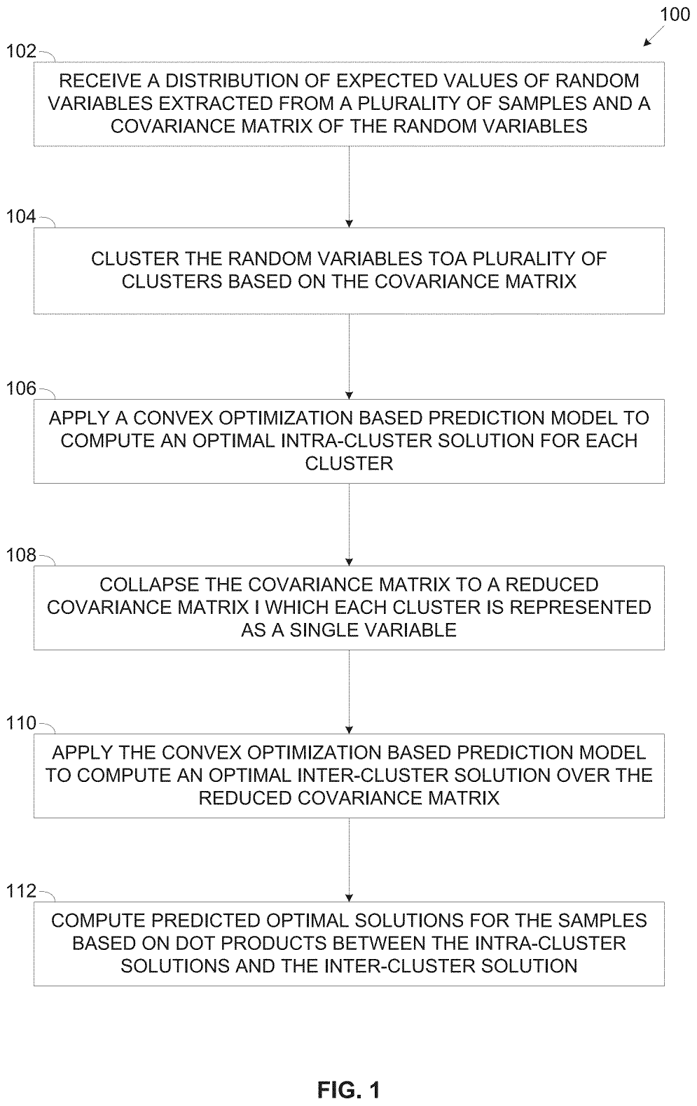

Referring now to the drawings, FIG. 1 is a flowchart of an exemplary process of improving accuracy while reducing computation load of a convex optimization based prediction model, according to some embodiments of the present invention.

An exemplary process 100 may be executed for enhancing a convex optimization based prediction model configured to predict optimal solutions (optimal points) for a given set of samples comprising a plurality of random variables. In particular, the convex optimization based prediction model is enhanced to increase its prediction accuracy while significantly reducing its computation load, i.e. reducing computing resources, for example, processing resources, processing time, storage resources and/or the like required for computing the predicted optimal solutions.

The process 100 utilizes a Nested Clustered Optimization (NCO) in which the random variables are clustered to clusters of highly correlated (codependent) random variables and computing inter-cluster optimal solutions across all clusters and combing the two to predict overall optimal solutions.

According to some embodiments of the present invention, the convex optimization based prediction model is applied for one or more financial investment prediction applications, i.e., to determine an allocation of an investment in a plurality of financial assets, for example, bank deposits, bonds, stocks, commodities and/or the like predicted to produce optimal outcomes, i.e. return of investment, revenues and/or the like. In such embodiments the samples dataset may include trading observations which may be analyzed to extract one or more trading features characteristic of the trading arena, for example, a market, an exchange (stock, commodities, metals, etc.) and/or the like.

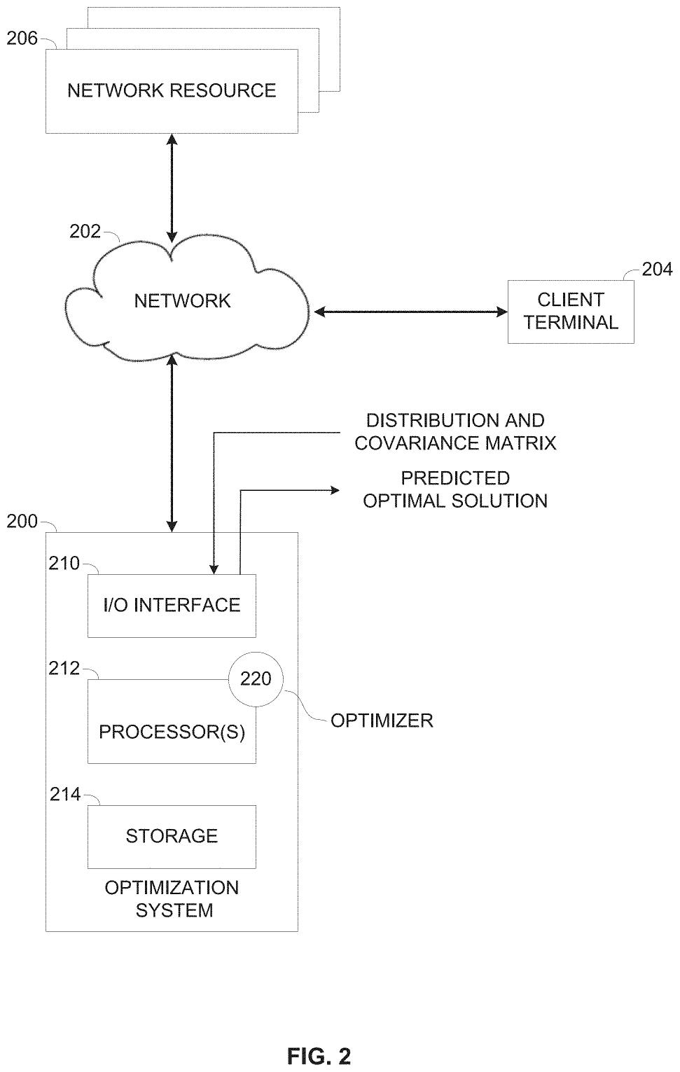

Reference is also made to FIG. 2, which is a schematic illustration of an exemplary system for improving accuracy while reducing computation load of a convex optimization based prediction model, according to some embodiments of the present invention. An exemplary optimization system 200 may be used for executing the process 100 for enhancing one or more convex optimization based prediction models.

The optimization system 200, for example, a computer, a server, a computing node, a cluster of computing nodes and/or the like may include an Input/Output (I/O) interface 210 for connecting to one or more external devices, systems, services and/or the like, a processor(s) 212 for executing the process 100 and a storage 214 for storing data and/or code (program store).

The I/O interface 210 may include one or more wired and/or wireless network interfaces for connecting to a network 202 comprising one or more wired and/or wireless networks, for example, a Local Area Network (LAN), a Wide Area Network (WAN), a Metropolitan Area Network (MAN), a cellular network, the internet and/or the like. Using the network interface(s) the optimization system 200 may communicate, via the network 202, with one or more remote network resources 206, for example, a server, a computing node, a storage server, a networked database, a cloud service and/or the like. Through the network 202 the optimization system 200 may further communicate with one or more client terminals 204, for example, a computer, a server, a laptop, a mobile device and/or the like used by one or more users, for example, an operator, a researcher and/or the like.

The I/O interface 210 may further include one or more wired and/or wireless I/O interfaces, ports, interconnections and/or the like for connecting to one or more external devices, for example, a Universal Serial Bus (USB) interface, a serial interface, a Radio Frequency (RF) interface, a Bluetooth interface and/or the like. The I/O interface 210, the optimization system 200 may communicate with one or more external devices attached to the I/O interface(s), for example, an attachable mass storage device, an external media device and/or the like.

The optimization system 200, communicating with one or more of the external devices and/or network resources 206, may therefore receive, fetch, collect and/or otherwise obtain data and information required for enhancing one or more of the convex optimization based prediction models configured for computing optimal solutions for one or more optimization problems. Such data and information may include, for example, one or more datasets comprising samples comprising and/or expressing a plurality of random variables, a distribution of one or more of the random variables, specifically a distribution of expected values of the random variables, a covariance matrix of the random variables, a correlation matrix of the random variables, execution rules and/or the like.

The processor(s) 212, homogenous or heterogeneous, may include one or more processing nodes arranged for parallel processing, as clusters and/or as one or more multi core processor(s). The storage 214 may include one or more tangible, non-transitory persistent storage devices, for example, a hard drive, a Flash array and/or the like. The storage 214 may also include one or more volatile devices, for example, a Random Access Memory (RAM) component, a cache and/or the like. The storage 214 may further comprise one or more local and/or remote network storage resources, for example, a storage server, a Network Attached Storage (NAS), a network drive, a cloud storage service and/or the like accessible via the I/O interface 210.

The processor(s) 212 may execute one or more software modules such as, for example, a process, a script, an application, an agent, a utility, a tool, an Operating System (OS) and/or the like each comprising a plurality of program instructions stored in a non-transitory medium (program store) such as the storage 214 and executed by one or more processors such as the processor(s) 212. The processor(s) 212 may further include, utilize and/or otherwise facilitate one or more hardware modules (elements), for example, a circuit, a component, an IC, an Application Specific Integrated Circuit (ASIC), a Field Programmable Gate Array (FPGA), a Digital Signals Processor (DSP), a Graphic Processing Units (GPU), an Artificial Intelligence (AI) accelerator and/or the like.

The processor(s) 212 may therefore execute one or more functional modules utilized by one or more software modules, one or more of the hardware modules and/or a combination thereof. For example, the processor(s) 212 may execute an optimizer functional module 220 for enhancing one or more of the convex optimization based prediction models.

Optionally, the optimization system 200, specifically the optimizer 220 are utilized by one or more cloud computing services, platforms and/or infrastructures such as, for example, Infrastructure as a Service (IaaS), Platform as a Service (PaaS), Software as a Service (SaaS) and/or the like provided by one or more vendors, for example, Google Cloud, Microsoft Azure, Amazon Web Service (AWS) and Elastic Compute Cloud (EC2) and/or the like.

One or more of the client terminals 204 may execute one or more applications, services and/or tools for communicating with the training system 200 and more specifically with the optimizer 220 to enable one or more of the users to interact with the optimizer 220. For example, one or more client terminals 204 may execute a web browser for communicating with the prediction models constructor 220 and presenting a User Interface (UI), specifically a Graphical UI (GUI) which may be used by the respective users to interact with the optimizer 220. In another example, one or more client terminals 204 may execute a local agent which communicates with the optimizer 220 and presents a GUI which may be used by the respective users to interact with the optimizer 220.

As shown at 102, the process 100 starts with the optimizer 220 receiving, fetching, collecting and/or otherwise obtaining a distribution of a plurality of random variables, specifically a distribution of expected values of the random variables and a covariance matrix of the random variables. The received distribution of the expected values may be expressed by an array designated y herein after and the received covariance matrix may be designated V herein after.

The plurality of random variables, for example, N random variables may be extracted from a plurality of random samples X included in one or more datasets. For example, in case of the convex optimization applied for investment performance prediction, the plurality of random samples may include a plurality of past trading observations randomly selected from one or more historical datasets.

The optimization problem to which the convex optimization based prediction model is applied, i.e. the goal of the convex optimization based prediction model may be to minimize the variance of the random values which may be measured by ω′Vω, subject to achieving a target ω′a, where a characterizes the optimal solution. In its simplest form, the optimization problem may be therefore stated by equation 1 below.

$${min}_{ω} \frac{1}{2} {ω}^{′} V ω \\ s . t . : {ω}^{′} a = 1 \qquad Equation 1$$

For example, in the financial investment prediction application(s), the goal of the convex optimization based prediction model may be the determine optimal allocations ω*, i.e. the investment allocations over a plurality of the financial assets that are predicted to produce (yield) optimal outcomes (returns, revenues). The optimal allocations ω* may be expressed by a maximal Sharpe Ratio (SR) of a portfolio of financial assets when a=μ, meaning that

$$\frac{{ω}^{′} μ}{\sqrt{{ω}^{′} V ω}}$$

is maximized where 1_{N} is a vector of ones of size N, and is thus the minimum variance portfolio when a=1_{N}, i.e., it minimizes ω′Vω.

Applying the convex optimization based prediction model, the optimal solution ω* to the optimization problem expressed in equation 1 may be expressed by equation 2 below which may be referred as the Convex Optimization Solution (CVO).

$${ω}^{*} = \frac{{V}^{- 1} a}{{a}^{′} {V}^{- 1} a} \qquad Equation 2$$

For clarity and brevity, the problem statement expressed herein above in equations 1 and 2 will serve to describe embodiments of the present invention. This, however, should not be construed as limiting since the described embodiments may be applicable for other optimization problems of possible more general nature, including optimization problems which incorporate a variety of inequality constraints, non-linear constraints, penalty functions (e.g., functions that penalize deviations in ω* from prior levels of ω*) and/or the like.

A common approach for estimating the optimal ω* expressed in equation 2 is to compute a predicted optimal solution \hat{ω}* according to equation 3 below.

$${\hat{ω}}^{*} = \frac{{\hat{V}}^{- 1} \hat{a}}{{\hat{a}}^{′} {\hat{V}}^{- 1} \hat{a}} \qquad Equation 3$$

where \hat{V} is an estimated V, and â is an estimated a.

However, replacing each random variable with a respective estimated variable may lead to unstable solutions since a small change in the input variables may cause extreme instability and changes in the predicted optimal solution \hat{ω}*.

One major contributor to changes in the input variables which in turn inflict major instability on the predicted optimal solution \hat{ω}* may be traced to instability caused by noise inherent to and/or included in the random variables.

Assuming a matrix of independent and identically distributed random variables X of size T×N which are generated from an underlying process having a zero mean and a variance σ². A matrix C=T⁻¹X′X has eigenvalues λ which may asymptotically converge to the Marcenko-Pastur Probability Density Function since N→+∞ and T→+∞ with 1<T/N<+∞) as expressed in equation 4 below.

$$f [ λ ] = \{ \begin{matrix}\frac{T}{N} \frac{\sqrt{( {λ}_{+} - λ ) ( λ - {λ}_{-} )}}{2 π λ {σ}^{2}} & if λ ∈ [ {λ}_{-} , {λ}_{+} ] \\ 0 & if λ ∉ [ {λ}_{-} , {λ}_{+} ]\end{matrix} \qquad Equation 4$$

where the maximum expected eigenvalue is

$${λ}_{+} = {{σ}^{2} ( 1 + \sqrt{\frac{N}{T}} )}^{2} ,$$

and the minimum expected eigenvalue is

$${λ}_{-} = {{σ}^{2} ( 1 - \sqrt{\frac{N}{T}} )}^{2} .$$

As known in the art, when σ²=1, then the matrix C is the correlation matrix associated with the random variables X. As explained by the Marcenko-Pastur distribution empirical covariance matrices may contain substantial amounts of noise. In many practical applications,

$$\frac{N}{T} \to 1 ,$$

thus the covariance's eigenvalues span a wide range [λ₋, λ₊]. This may lead to major instability in the prediction of the predicted optimal solution \hat{ω}* since estimating the predicted optimal solution \hat{ω}* requires an estimation of \hat{V}⁻¹ which may not be robustly estimated in the presence of small eigenvalues in which the determinant is almost zero.

The optimizer 220 may therefore optionally de-noise the received random variables in order to reduce the instability in the predicted optimal solution \hat{ω}* which results from changes in the input variables induced by the noise.

To this end the optimizer 220 may apply one or more de-noising functions configured to identify noise components and signal components in each of at least some of the plurality of random variables. In particular, the noise components may be distinctly identified from the signal components according to their corresponding eigenvalues computed based on the received covariance matrix V.

The de-noising function(s) may be further configured to reduce and potentially remove the identified noise components thus eliminating the impact of noise on the input random variables which may enable the optimizer to compute a significantly more accurate prediction of the optimal solution \hat{ω}*.

The de-noising function(s) may first compute a correlation matrix associated with the covariance matrix V and may derive, from the correlation matrix, the eigenvalues and eigenvectors for the correlation matrix V. The de-noising function(s) may then use one or more methods, techniques and/or algorithms, for example, the Kernel Density Estimate (KDE) algorithm to fit the Marcenko-Pastur distribution to the empirical distribution of computed eigenvalues. Fitting the Marcenko-Pastur distribution over the empirical distribution of computed eigenvalues may separate the eigenvalues corresponding (relating) to the noise components from the eigenvalues corresponding (relating) to the signal components. The de-noising function(s) may reduce (shrink) the eigenvalues associated with noise components while leaving the eigenvalues associated with the signal components unchanged. A de-noised covariance matrix recovered from the de-noised correlation matrix may be then used herein after to minimize the instability effects induced by the noise components.

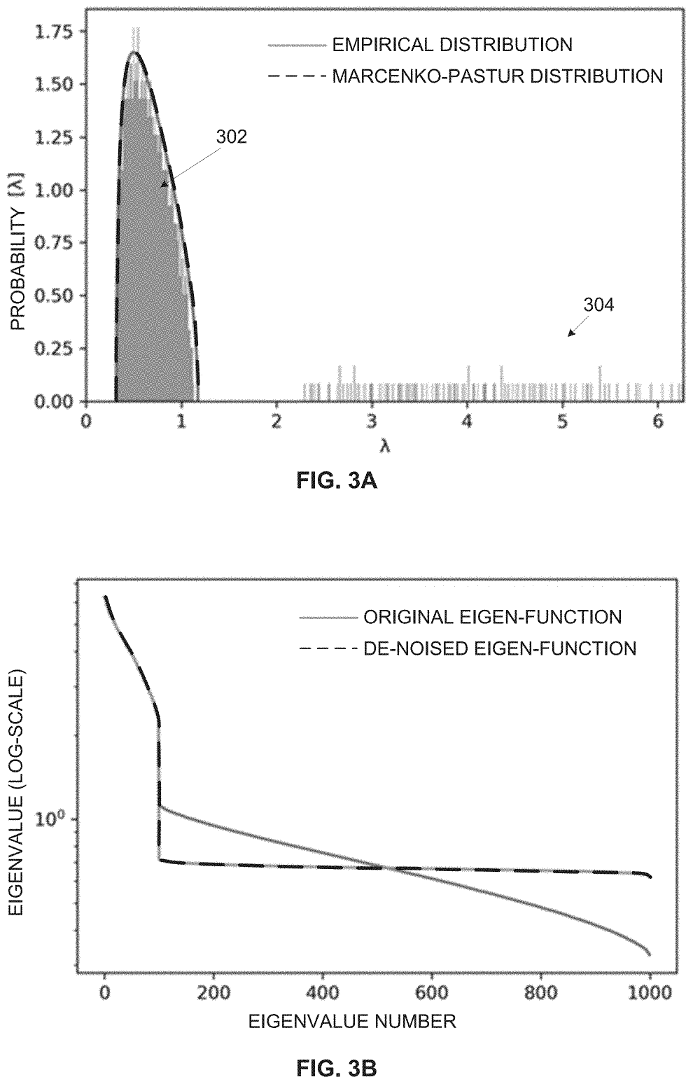

Reference is now made to FIG. 3A and FIG. 3B, which are graph charts reflecting a de-noising process applied to a distribution of eigenvalues associated with noise and signal components of a received distribution of expected values of random variables to de-noise the random variables, according to some embodiments of the present invention.

FIG. 3A is a graph chart presenting a distribution of eigenvalues computed for an exemplary set of random variables based on their covariance matrix by an optimizer such as the optimizer 220, specifically using one or more of the de-noising functions. As seen, the de-noising function(s) may fit the Marcenko-Pastur distribution over the empirical distribution of computed eigenvalues which may distinctly separate the eigenvalues 302 associated with noise components from the eigenvalues 304 associated with the signal components.

FIG. 3B is a graph chart showing how the optimizer 220, specifically the de-noising function(S) applied by the optimizer 220, may replace an original Eigen-function with a de-noised Eigen-function for processing the fitted eigenvalues thus shrinking (reducing) only the eigenvalues associated with noise while leaving unchanged the eigenvalues associated with signal. This may present a major advantage and enhancement over existing de-noising methods which do not discriminate between the noise-related eigenvalues and the signal-related eigenvalues and hence shrink the covariance matrix at the expense of diluting at least part of the signal.

A set of exemplary de-noising functions is described in code snippet 1 below.

### Code Snippet 1:

```
from sklearn.neighbors.kde import KernelDensity
from scipy.optimize import minimize
#------------------------------------------------------------------------------
def corr2cov(corr,std):
  cov=corr*np.outer(std,std)
  return cov
#------------------------------------------------------------------------------
def cov2corr(cov):
  # Derive the correlation matrix from a covariance matrix
  std=np.sqrt(np.diag(cov))
  corr=cov/np.outer(std,std)
  corr[corr<−1],corr[corr>1]=−1,1 # numerical error
  return corr
  #------------------------------------------------------------------------------
def getPCA(matrix):
  # Get eVal,eVec from a Hermitian matrix
  eVal,eVec=np.linalg.eigh(matrix)
  indices=eVal.argsort( )[::−1] # arguments for sorting eVal desc
  eVal,eVec=eVal[indices],eVec[:,indices]
  eVal=np.diagflat(eVal)
  return eVal,eVec
#------------------------------------------------------------------------------
def denoisedCorr(eVal,eVec,nFacts):
  # Remove noise from corr by fixing random eigenvalues.
  eVal_=np.diag(eVal).copy( )
  eVal_[nFacts:]=eVal_[nFacts:].sum( )/float(eVal_.shape[0]-nFacts)
  eVal_=np.diag(eVal_)
  corr1=np.dot(eVec,eVal_).dot(eVec.T)
  corr1=cov2corr(corr1)
  return corr1
#------------------------------------------------------------------------------
def findMaxEval(eVal,q,bWidth):
  # Find max random eVal by fitting Marcenko's dist to the empirical one
  out=minimize(lambda *x:errPDFs(*x),.5,args=(eVai,q,bWidth),
```

bounds=((1E−5,1−1E−5),))

```
  if out]‘success’]:var=out[‘x’][0]
  else:var=1
  eMax=var*(1+(1./q)**.5)**2
  return eMax,var
#------------------------------------------------------------------------------
def deNoiseCov(cov0,q,bWidth):
  corr0=cov2corr(cov0)
  eVal0,eVec0=getPCA(corr0)
  eMax0,var0=findMaxEval(np.diag(eVal0),q,bWidth)
  nFacts0=eVal0.shape[0]−np.diag(eVal0)[::−1].searchsorted(eMax0)
  corr1=denoisedCorr(eVal0,eVec0,nFacts0)
  cov1=corr2cov(corr1,np.diag(cov0))
    return cov1
```

A function deNoiseCov may compute the correlation matrix associated with a given covariance matrix, and may derive the eigenvalues and eigenvectors for that correlation matrix. A function findMaxEval may use the KDE algorithm to fit the Marcenko-Pastur distribution to the empirical distribution of eigenvalues. A function denoisedCorr may shrink the eigenvalues associated with the noise and may return a de-noised correlation matrix. A function corr2cov may then recover the covariance matrix from the de-noised correlation matrix.

As shown at 104, the optimizer 220 may cluster the plurality of random variables to a plurality of clusters based on the covariance matrix such that each of the plurality clusters comprises a respective subset of highly codependent expected values. This means that a result of the clusters partitioning is a collection of mutually disjoint non-empty subsets of variables each associated with a respective cluster.

Optionally, in case de-noising was applied to the random variables, the optimizer 220 may cluster the plurality of random variables to a plurality of clusters based on the de-noised covariance matrix recovered from the de-noised correlation matrix in which the noise-related eigenvalues are reduced (shrunk).

To cluster the random variables to the clusters, the optimizer 220 may apply to the covariance matrix or optionally to the de-noised covariance matrix one or more trained ML models, for example, a neural network, an SVM and/or the like. The ML model(s) may be trained to cluster the random variables to the clusters in one or more supervised, semi-supervised and/or non-supervised training sessions using training datasets comprising training samples, specifically random variables of the same type, category and/or characteristics as the received random variables.

As shown at 106, the optimizer 220 may apply a convex optimization based prediction model to compute predicted optimal intra-cluster solutions for each of the plurality of clusters. In other words, the convex optimization based prediction model is applied to compute optimal solutions for each of the clusters separately which may be highly accurate, coherent and/or stable due to the high correlation (codependency) of the expected values of the random values in each of the clusters.

Specifically, the convex optimization based prediction model may compute the predicted optimal intra-cluster solutions for each cluster based on a respective covariance matrix associated with the respective cluster which expresses the variance between the subset of random variables contained in the respective cluster.

As shown at 108, the optimizer 220 may collapse the covariance matrix, optionally the de-noised covariance matrix to a reduced covariance matrix based on the predicted optimal intra-cluster solutions computed for each of the plurality of clusters.

The reduced covariance matrix is constructed such that each of the plurality of clusters is represented as a single variable based on the predicted optimal intra-cluster solution computed for each cluster. The reduced (collapsed) correlation matrix associated with the reduced covariance matrix is closer to an identity matrix compared to the original correlation matrix of the random variables. The reduced correlation matrix may be therefore more amenable to optimization problems.

The reduced correlation matrix may thus serve to overcome at least partially a second root cause of instability of the predicted optimal solution \hat{ω}* which may be traced to a structure of the input signal i.e. to the structure of the received random variables, specifically the structure of the received covariance matrix.

To demonstrate such instability in the predicted optimal solution \hat{ω}*, without loss of generality, a correlation matrix C between two variables may be expressed by equation 5 below.

$$C = [ \begin{matrix}1 & ρ \\ ρ & 1\end{matrix} ] \qquad Equation 5$$

where ρ is the correlation between the solutions, for example, outcomes of the two variables.

The correlation matrix C may be diagonalized as CW=WΛ according to equation 6 below.

$$Λ = [ \begin{matrix}1 + ρ \\ 1 - ρ\end{matrix} ] ; W = [ \begin{matrix}\frac{1}{\sqrt{2}} & \frac{1}{\sqrt{2}} \\ \frac{1}{\sqrt{2}} & - \frac{1}{\sqrt{2}}\end{matrix} ] \qquad Equation 6$$

The inverse matrix of the correlation matrix C is

$${C}^{- 1} = W {Λ}^{- 1} {W}^{′} = \frac{1}{\vert C \vert} [ \begin{matrix}1 & - ρ \\ - ρ & 1\end{matrix} ] ,$$

where |C| is the determinant of C, |C|=Λ_{1,1}Λ_{2,2}=(1+ρ)(1−ρ)=1−ρ².

From the above, it may be seen that the more p deviates from zero, the bigger one eigenvalue becomes relative to the other, causing the determinant of C to approach zero which may cause the values of C⁻¹ to become extremely large (explode).

To intuitively explain the impact of the signal structure on the stability of the predicted optimal solution \hat{ω}*, in the ideal case, when the correlation matrix is an identity matrix, the eigenvalue function may be expressed as a horizontal line. Outside that ideal case, a subset of random variables may exhibit greater correlation among themselves than to the rest of the random variables thus forming a cluster within the correlation matrix. Clusters appear naturally, as a consequence of hierarchical relationships. When a subset of K random variables of the N random variables form a cluster, the K random variables may be more heavily exposed to a common eigenvector, which implies that the associated eigenvalue explains a greater amount of variance. However, since the trace of the correlation matrix is exactly N, an eigenvalue may only increase at the expense of the other N−K eigenvalues, resulting in a drop in the determinant of the correlation matrix. This source of instability is distinct and unrelated to

$$\frac{N}{T} \to 1.$$

Therefore, clustering the random variables to the clusters and collapsing the clusters to the reduced covariance matrix based on the intra-cluster optimal solutions computed for each of the clusters may significantly reduce the instability of the predicted optimal solution \hat{ω}* induced by the signal structure.

Moreover, since the instability is contained within each cluster and the instability caused by intra-cluster noise therefore does not propagate across clusters.

As shown at 110, the optimizer 220 may apply the convex optimization based prediction model to compute a predicted optimal inter-cluster solution over (across) the reduced covariance matrix in which each of the clusters is represented by a single variable.

As shown at 112, the optimizer 220 may predict the optimal solution \hat{ω}* for the plurality of samples, i.e. the received random variables, based on a plurality of dot products computed between the optimal intra-cluster solutions and the optimal inter-cluster solution. In particular, the computed dot products may serve to adjust the weights of the convex optimization based prediction model which is applies to predict the optimal solution \hat{ω}*.

Applying the process 100 in which the optimal solution \hat{ω}* is predicted by separately computing the predicted optimal intra-cluster solutions and the predicted optimal inter-cluster solution may significantly reduce a computation load of the convex optimization based prediction model. The computation load, for example the processing resources, the processing time, the storage resources and/or the like may be significantly reduced since the magnitude and dimensions of the optimization problem are dramatically reduced.

First the number of clusters may be very small compared to the number of the random variables and the dimensions of the reduced covariance matrix may be thus extremely reduced compared to the original covariance matrix of the random variables. Computing the optimal inter-cluster solution over the reduced dimensions covariance matrix may thus significantly reduce the computing load. Second, the computing load for computing the optimal intra-cluster solutions for each of the clusters may be also significantly reduced since each of the clusters contains only a subset of the plurality of random variables which also significantly reduces the dimensions of the covariance matrix associated with each cluster. Furthermore, since the clusters are independent of each other, the optimal intra-cluster solutions may be computed in parallel thus further reducing the computing time of the optimization process.

Moreover, the predicted optimal solution \hat{ω}* computed according to the process 100 may be significantly more accurate due to the increased robustness and/or immunity of the prediction process to the instability induced by the noise in the input random variables and/or by the signal structure, i.e. by the structure of the random variables' covariance and correlation matrices.

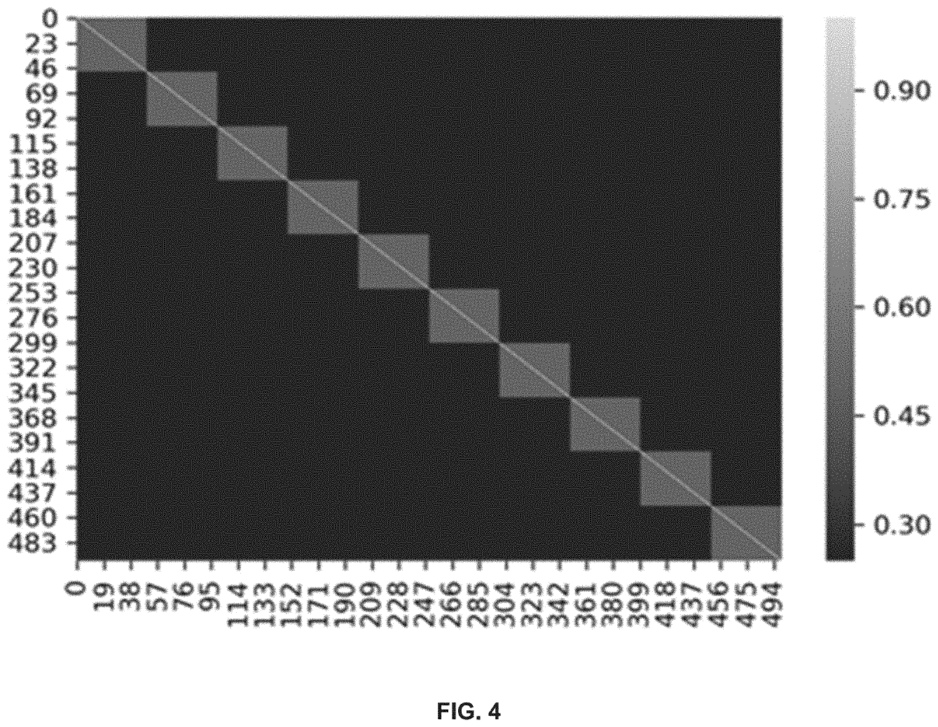

Reference is now made to FIG. 4, which is a schematic illustration of an exemplary clustering of a correlation matrix of expected values of a plurality of random variables to a limited number of clusters each comprising highly codependent expected values, according to some embodiments of the present invention.

FIG. 4 illustrates a correlation matrix of 500 random variables partitioned (clustered) into 10 clusters each containing 50 highly-correlated random variables. An optimizer such as the optimizer 220 executing a process such as the process 100 may first apply the convex optimization based prediction model to separately compute the optimal intra-cluster solutions (weights, allocations) for each of the clusters. The optimizer 220 may then collapse the 500×500 correlation matrix into the 10×10 reduced correlation matrix and may apply the optimization based prediction model to compute the optimal intra-cluster solutions (weights, allocations) across the 10×10 correlation matrix. The optimizer 22o may then compute the final weights of the optimization based prediction model based on the dot-product of the intra-cluster and inter-cluster weights.

The NCO process 100 may be executed using an exemplary set of functions described in code snippet 2 below.

### Code Snippet 2:

```
from sklearn.cluster import KMeans
from sklearn.metrics import silhouette_samples
#------------------------------------------------------------------------------
def clusterKMeansBase(corr0,maxNumClusters=None,n_init=10):
  dist,silh=((1-corr0.fillna(0))/2.)**−5,pd.Series( ) # distance matrix
  if maxNumClusters is None:maxNumClusters=corr0.shape[0]/2
  for init in range(n_init):
```

```
for i in xrange(2,maxNumClusters+1): # find optimal num clusters
  kmeans_=KMeans(n_clusters=i,n_jobs=1,n_init=1)
  kmeans_=kmeans_.fit(dist)
  silh_=silhouette_samples( dist,kmeans_. labels_)
  stat=(silh_.mean( )/silh_.std( ),silh.mean( )/silh.std( ))
  if np.isnan(stat[1]) or stat[0]>stat[1]:
```

silh,kmeans=silh_,kmeans_{—}

```
  newIdx=np.argsort(kmeans.labels_)
  corr1=corr0.iloc[newIdx] # reorder rows
  corr1=corr1.iloc[:,newIdx] # reorder columns
  clstrs={i:corr0.columns[np.where(kmeans.labels_==i)[0]].tolist( ) for \
```

i in np.unique(kmeans.labels_)} # cluster members

```
  silh=pd.Series(silh,index=dist.index)
  return corr1,clstrs,silh
#------------------------------------------------------------------------------
def optPort(cov,mu=None):
  inv=np.linalg.inv(cov)
  ones=np.ones(shape=(inv.shape[0],1))
  if mu is None:mu=ones
  w=np.dot( inv,mu)
  w/=np.dot(ones.T,w)
  return w
#------------------------------------------------------------------------------
def optPort_nco(cov,mu=None,maxNumClusters=None):
  cov=pd.DataFrame(cov)
  if mu is not None:mu=pd.Series(mu[:,0])
  corr1=cov2corr(cov)
  corr1,clstrs,_=clusterKMeansBase(corr1,maxNumClusters,n_init=10)
  wIntra=pd.DataFrame(0,index=cov.index,columns=clstrs.keys( ))
  for i in clstrs:
```

cov_=cov.loc[clstrs[i],clstrs[i]].values
mu_=(None if mu is None else
mu.loc[clstrs[i]].values.reshape(−1,1))
wIntra.loc[clstrs[i],i]=optPort(cov_,mu_).flatten( )

```
  cov_=wIntra.T.dot(np.dot(cov,wIntra)) # reduce covariance matrix
  mu_=(None if mu is None else wIntra.T.dot(mu))
  \wInter=pd.Series(optPort(cov_,mu_).flatten( ),index=cov_.index)
  nco=wIntra.mul(wInter,axis=1).sum(axis=1).values.reshape(−1,1)
  return nco
```

A function optPort_nco may invoke a function clusterKMeansBase to identify an optimal partition scheme of clusters, and may then invoke a function optPort for each of the clusters. The function optPort may apply one or more convex optimization based prediction models to compute the intra-cluster optimal solutions. The convex optimization based prediction model(s) may be selected and/or defined by a user since the function optPort_nco is agnostic as to the selected convex optimization based prediction model(s). Without loss of generality, in this particular implementation, optPort may estimate the optimal solution for the financial investment prediction application(s), i.e. the portfolio of financial assets predicted to produce the maximal outcomes. When an argument mu is None, the function optPort_nco may return the minimum variance portfolio, whereas when the argument mu is not None, the function optPort_nco may return the portfolio exhibiting the maximum Sharpe Ratio.

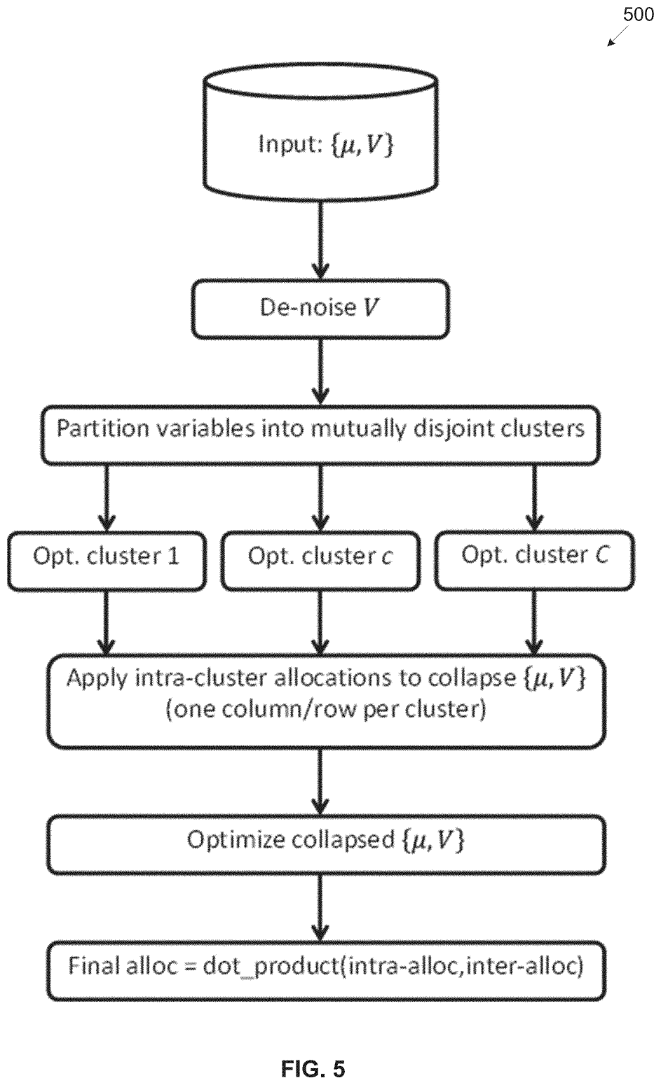

Reference is now made to FIG. 5, which is a schematic illustration of an exemplary sequence for improving accuracy while reducing computation load of a convex optimization based prediction model, according to some embodiments of the present invention.

An exemplary sequence 500 may be followed by an optimizer such as the optimizer 220 executing a process such as the process 100 to apply the NCO for enhancing one or more convex optimization based prediction models. The starting point is a set of inputs, represented by the pair {μ, V} representing the expected values (e.g. means) and covariances of N random variables.

The optimizer 220 may optionally de-noises the covariance matrix V as described in step 102 of the process 100. The optimizer 220 may then partition the de-noised covariance matrix V into C mutually-disjoint clusters. The optimizer 220 may apply the convex optimization based prediction model(s) to optimize independently and optionally in parallel all of the C clusters, i.e. compute the optimal intra-cluster solutions thus minimizing the time needed to complete this optimization task. The result is a set of C intra-cluster weights (optimal intra-cluster solutions). The optimizer 220 may apply the intra-cluster weights to collapse the pair {μ, V} from N random variables to C variables since each cluster may be represented as a single variable based on the respective intra-cluster weight. The optimizer 220 may further the convex optimization based prediction model(s) to optimize the collapsed pair {μ, V} to derive the inter-cluster weights (optimal inter-cluster solutions). Finally, the optimizer 220 may compute the predicted optimal solutions (weights), of order N×1, based on the dot-product computed between the intra-cluster solutions (allocations), of order N×C, with the inter-cluster solutions (allocations) of order C×1.

According to some embodiments of the present invention, there are provided methods and systems for selecting a best performing prediction model from a plurality of prediction models to compute an optimal solution for a certain dataset comprising a plurality of samples. The plurality of different prediction models which may include the NCO convex optimization based prediction model may be applied to compute optimal solutions (optimal point) for the certain dataset.

An estimation error may be computed for the optimal solutions computed by each of the prediction models and the prediction model which presents a smallest estimation error may be selected as it is expected to be the best performing prediction model for the certain dataset.

In particular, the optimal solutions computed by each of the prediction models are based on simulated data generated by a Monte Carlo algorithm based on a Data-Generating Process (DGP) which may be user defined and derived from the received dataset. The process 600 may be thus designated Monte Carlo Optimization Selection (MCOS).

The prediction model selection process may be applied for each received certain dataset such that a respective best performing prediction model may be selected for each received dataset. Each dataset may reflect and express different scenarios, conditions, circumstances and/or the like relating to the prediction problem. Moreover, each of the different prediction models may be optimized for different such problem characteristics. Therefore, applying and testing the plurality of prediction models for each received dataset to identify and select the best performing prediction model for each dataset may significantly improve the prediction accuracy of the optimal solutions computed for each dataset.

According to some embodiments of the present invention, the plurality of prediction models are used by one or more financial investment prediction applications to determine an optimal allocation of an investment over a plurality of financial assets, for example, bank deposits, bonds, stocks, commodities and/or the like predicted to produce optimal outcomes, i.e. return of investment, revenues and/or the like. In such embodiments the samples dataset may include trading observations which may be analyzed to extract one or more trading features characteristic of the trading arena, for example, a market, an exchange (stock, commodities, metals, etc.) and/or the like.

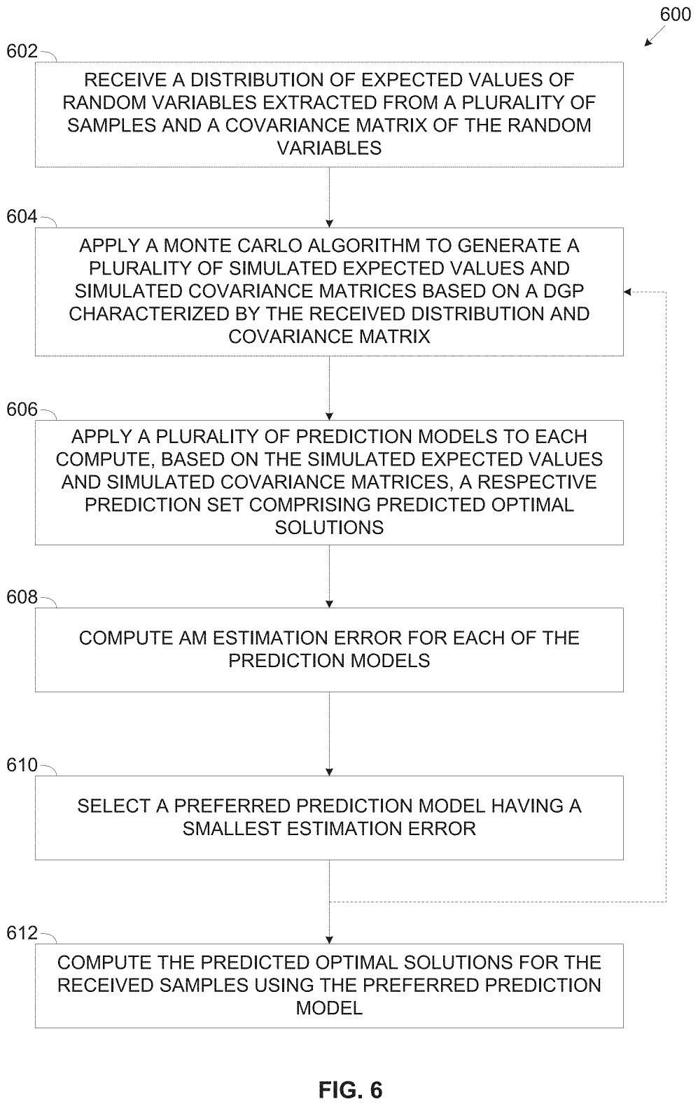

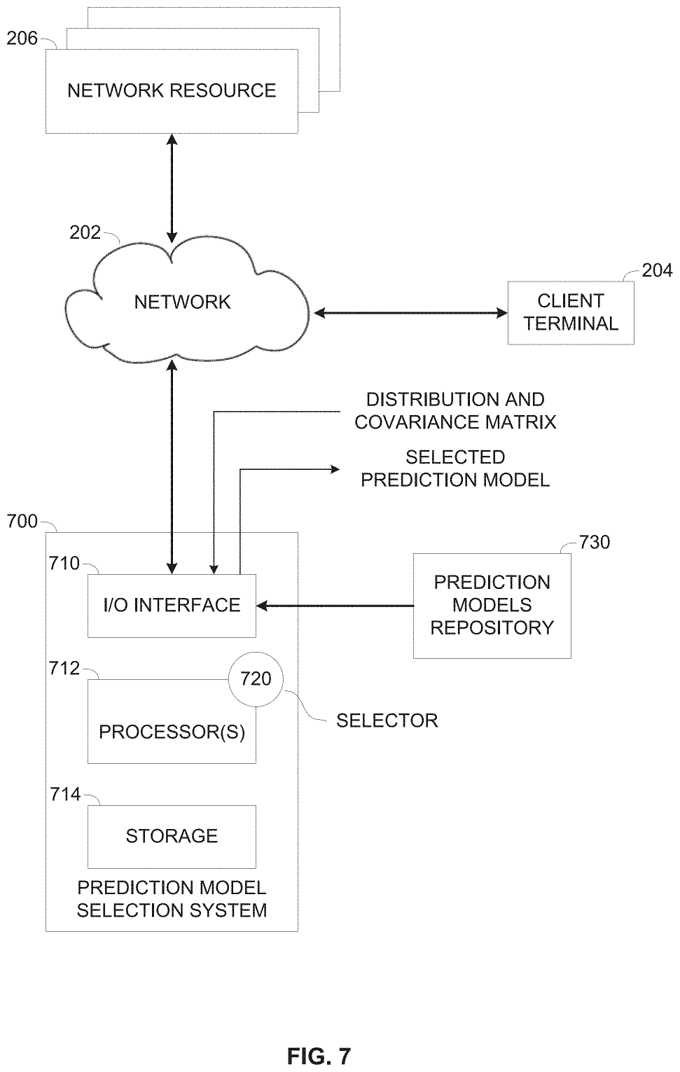

Reference is now made to FIG. 6, is a flowchart of an exemplary process of selecting a best performing prediction model for a certain dataset of samples, according to some embodiments of the present invention. Reference is also made to FIG. 7, which is a schematic illustration of an exemplary system for selecting a best performing prediction model for a certain dataset of samples, according to some embodiments of the present invention.

An exemplary process 600 may be executed by an exemplary prediction model selection system 700 for selecting a best performing prediction model from a plurality of prediction models for each received dataset comprising a plurality of samples.

The prediction model selection system 400, for example, a computer, a server, a computing node, a cluster of computing nodes and/or the like may include an I/O interface 710 such as the I/O interface 210 for connecting to one or more external devices, systems, services and/or the like, a processor(s) 712 such as the processor(s) 212 for executing the process 400 and a storage 714 such as the storage 214 for storing data and/or code (program store).

Through the I/O interface 710, the prediction model selection system 400, communicating with one or more of the external devices and/or network resources 206, may receive, fetch, collect and/or otherwise obtain data and information required for selecting the best performing prediction model for each received dataset. The received data may include, for example, one or more datasets comprising samples comprising and/or expressing a plurality of random variables, a distribution of one or more of the random variables, specifically a distribution of expected values of the random variables, a covariance matrix of the random variables, a correlation matrix of the random variables, execution rules and/or the like.

Via the I/O interface 710, the prediction model selection system 400 may further communicate with a prediction models repository 730 storing the plurality of prediction models. The prediction models repository 730 may be implemented, for example, through one or more networked resource such as the networked resources 206 accessible by the prediction model selection system 400 via the network 202. In another example, the prediction models repository 730 may be implemented using one or more external devices attached to one or more of the ports available by the I/O interface 710 and thus accessible to the prediction model selection system 400.

The prediction model selection system 400 may further communicate with one or more client terminals such as the client terminal 204 used by one or more users, for example, an operator, a researcher, a trader and/or the like to receive instructions, prediction rules, optimization constraints and/or the like and/or to output (transmit) an indication of the selected best performing prediction model estimated to produce best optimization for one or more received datasets.

The processor(s) 712 may be constructed as the processor(s) 212 and similarly the storage 714 may be constructed as the storage 214. The processor(s) 712 which may therefore execute one or more functional modules utilized by one or more software modules, one or more of the hardware modules and/or a combination thereof. For example, the processor(s) 712 may execute a selector functional module 720 for selecting a best performing prediction model for one or more received datasets of samples.

Optionally, the prediction model selection system 400, specifically the selector 720 are utilized by one or more cloud computing services, platforms and/or infrastructures such as, for example, IaaS, PaaS, SaaS and/or the like provided by one or more vendors, for example, Google Cloud, Microsoft Azure, AWS and EC2 and/or the like.

As shown at 602, the process 600 starts with the selector 720 receiving a distribution of expected values of a plurality of random variables extracted from a plurality of samples and a covariance matrix of the plurality of random variables.

As defined herein before, the input variables, i.e., the received distribution may be expressed by the array of expected outcomes y of N random variables and the received covariance matrix of the expected outcomes may be designated V. The input variables may optionally incorporate priors as known in the art.

As shown at 604, the selector 720 may apply the Monte Carlo algorithm which generates a plurality of simulated expected values and a plurality of simulated covariance matrices based on a DGP characterized by the received distribution and covariance matrix {μ, V} which may be treated as real values.

The DGP may be user-defined according to one or more paradigms and/or methods. For example, the DGP may be fitted on one or more historical datasets comprising samples captured in the past (e.g. past trading observations). In another example, the DGP may be based on one or more theoretical considerations. In another example, the DGP may be based on one or more personal beliefs, intuitions and/or the like of the user.

The Monte Carlo algorithm may draw a matrix X of simulated expected values from the distribution characterized by {μ, V}. The size of X is T×N, matching the number of variables (N) and a sample length T used to compute the original, real pair {μ, V}. From the matrix X, Monte Carlo algorithm may derive based on the user-defined DGP, as known in the art, a simulated pair {\hat{μ}, \hat{V}} comprising a plurality of simulated expected values and a plurality of simulated covariance matrices.

The Monte Carlo algorithm may be applied using an exemplary function simCovMu presented in snippet 3 below which is configured to draw the simulated pair {\hat{μ}, \hat{V}} fusing an exemplary code snippet 3 below. Optionally, the matrix X may be shrunk as known in the art.

### Code Snippet 3:

```
import numpy as np,pandas as pd
from sklearn.covariance import LedoitWolf
#------------------------------------------------------------------------------
def simCovMu(mu0,cov0,nObs,shrink=False):
  x=np.random.multivariate_normal(mu0.flatten( ),cov0,size=nObs)
  mu1=x.mean(axis=0).reshape(−1,1)
  if shrink:cov1=LedoitWolf( ).fit(x).covariance_{—}
  else:cov1=np.cov(x,rowvar=0)
  return mu1,cov1
```

Optionally, the optimizer 220 may de-noise the simulated covariance matrices received using one or more of the de-noising functions as described herein before in order to reduce the instability in the predicted optimal solution \hat{ω}* computed by the plurality of prediction models which may result from changes in the input variables induced by noise.

As shown at 606, the selector 720 may apply a plurality of prediction models configured to compute, based on the plurality of simulated expected values and the plurality of simulated covariance matrices, prediction sets comprising a plurality of predicted optimal solutions. Specifically, each of the prediction models may compute a respective set of predicted optimal solutions \hat{ω}* based on the simulated pair {\hat{μ}, \hat{V}} of expected values and covariance matrices.

The selector 720 may retrieve the prediction models from the prediction models repository 730. It should be noted that the selector 720 and the MCOS process 600 are agnostic with regards to the specific prediction models applied to compute the predicted optimal solutions \hat{ω}*. The applied prediction models may include, for example, one or more Convex Optimization based prediction (CVO) models including the NCO prediction model described herein before.

As shown at 608, the selector 720 may compute an estimation error for each of the plurality of prediction models based on a comparison between the predicted optimal solutions \hat{ω}* computed by the respective prediction model and a real optimal solution derived from the user-defined DGP.

In other words, the selector 720 may compare between the predicted optimal solutions \hat{ω}* computed by the respective prediction model based on the simulated pairs {\hat{μ}, \hat{V}} and the real optimal solution ω derived from the user-defined DGP which is characterized by the pair {μ, V} of the received distribution of expected values of the random variables and the covariance of these random variables. Specifically, the selector 720 may compute the real optimal solution ω according to equation 2 above. Based on the comparison, the selector 720 may compute the estimation error of the respective prediction model.

Specifically, for each of the prediction models, the selector 720 may compute a standard deviation of a differences between the predicted optimal solutions \hat{ω}* and the real optimal solution ω for each of the received random variables. The mean of the standard deviations across all variables may produce the estimation error associated with each of the prediction models.

In an alternative implementation, the selector 720 may compute and evaluate the estimation error in terms of the average decay in performance. The selector 720 may use one or more metrics for computing the average decay in performance. For example, the selector 720 may compute the average decay in performance based on the mean difference in the predicted optimal solutions, (\hat{ω}*−\vec{ω}*)′μ. In another example, the selector 720 may compute the average decay in performance based on the mean difference in the variance, (ω*−\hat{ω}*)′V(ω*−\hat{ω}*). In another example, specifically for the financial investment prediction application(s), the selector 720 may compute the average decay in performance based on the mean difference in Sharpe Ratio,

$$\frac{{( {ω}^{*} - {\hat{ω}}^{*} )}^{′} μ}{\sqrt{{( {ω}^{*} - {\hat{ω}}^{*} )}^{′} V ( {ω}^{*} - {\hat{ω}}^{*} )}} .$$

In another example, the selector 720 may compute the average decay in performance based on one or more ratio computed on any of the above statistics metrics.

The selector 720 may compute the estimation error for each of the prediction models using an exemplary code presented in code snippet 4 below.

### Code Snippet 4:

w0=optPort(cov0,None if minVarPortf else mu0)
w0=np.repeat(w0.T,w1.shape[0],axis=0) # true allocation
err=(w1-w0).std(axis=0).mean( )
err_d=(w1_d-w0).std(axis=0).mean( )

As shown at 610, the selector 720 may identify and select a preferred prediction model whose predicted optimal solution presents the smallest estimation error indicative that the selected preferred prediction model may compute (produce, yield) the most robust predicted optimal solutions \hat{ω}* for the received pair {μ, V} of input variables.

As shown at 612, the selector 720 may apply the selected preferred prediction model to compute the predicted optimal solutions \hat{ω}* for the received pair {μ, V} of input variables.

Optionally, the MCOS process 600 may be an iterative process comprising a plurality of iterations, where in each iteration the selector 720 may:
Execute step 604 to apply the Monte Carlo algorithm to generate the simulated pair {\hat{μ}, \hat{V}}. Wherein in each iteration the Monte Carlo algorithm generates another respective simulated pair (set) {\hat{μ}, \hat{V}}, comprising a plurality of respective simulated expected values and a plurality of respective simulated covariance, matrices based on the user-defined DGP.
Execute step 606 to apply the plurality of prediction models to compute the a respective predicted optimal solutions \hat{ω}* based on the respective simulated pair (set) {\hat{μ}, \hat{V}}.
Execute step 608 to compute a respective estimation error for each of the prediction models by comparing between the respective predicted optimal solutions \hat{ω}* computed by each prediction model and the real optimal solution ω computed based on the real pair {μ, V}.
Execute step 610 to select a preferred prediction model presenting the smallest respective estimation error.

The selector 720 may further aggregate the results of the plurality of iterations and may select the preferred prediction model which presents a smallest aggregated estimation error over the plurality of iterations.

The selector 720 may use an exemplary set of functions presented in code snippet 5 below to apply the iterative MCOS process in which the plurality of prediction models are applied to compute the predicted optimal solutions \hat{ω}* on a large number of simulated pairs {\hat{μ}, \hat{V}}.

### Code Snippet 5:

def monteCarlo(mu0,cov0,nObs,nSims,bWidth,minVarPortf,shrink):
w1=pd.DataFrame(columns=xrange(cov0.shape[0]),

ndex=xrange(nSims),dtype=float)

```
  w1_d=w1.copy(deep=True)
  for i in range(nSims):
```

mu1,cov1=simCovMu(mu0,cov0,nObs,shrink)
if minVarPortf:mu1=None
if bWidth>0:cov1=deNoiseCov(cov1,nObs*1./cov1.shape[1],bWidth)
w1.loc[i]=optPort(cov1,mu1).flatten( )
w1_d.loc[i]=optPort_nco(cov1,mu1,cov1.shape[0]/2).flatten( )

return

mu0 designates the original vector of expected outcomes, cov0 designates the original covariance matrix of outcomes, nObs designates the number of observations T used to compute mu0 and cov0, nSims designates the number of simulations run in the MCOS iterative process 600 and bWidth designates the bandwidth of the KDE functions used to de-noise the covariance matrix.

minVarPortf is a flag which when True instructs computing the minimum variance solution while otherwise instructs computing the maximum Sharpe Ratio solution. Shrink is another flag which when True instructs subjecting the covariance matrix to one or more shrinkage processes as known in the art, for example, the Ledoit-Wolf shrinkage procedure.

A function monteCarlo may repeats nSims times the following sequence:
(1) Given a pair {μ, V}, a function simCovMu draws nObs samples (observations) and uses those samples to compute a simulation pair {\hat{μ}, \hat{V}} optionally with shrinkage, if shrink=True).
(2) If minVarPortf, then drop \hat{μ}, because \hat{μ} is not needed to estimate the minimum variance portfolio.
(3) If bWidth>0, then deNoiseCov de-noises \hat{V}; (4) use {\hat{μ}, \hat{V}} to compute alternative solutions.

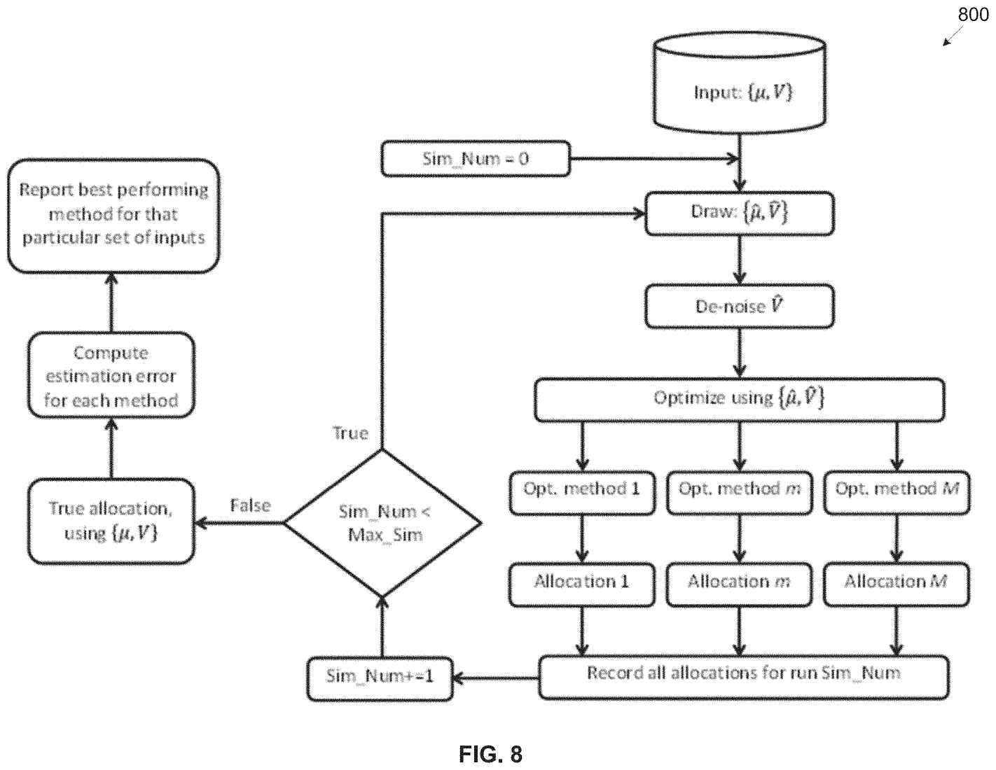

Reference is now made to FIG. 8, which is a schematic illustration of an exemplary sequence for selecting a best performing prediction model for a certain dataset of samples, according to some embodiments of the present invention.

An exemplary sequence 800 may be followed by a selector such as the selector 720 executing a process such as the MCOS process 600 to select a best performing prediction model for a given (received) dataset of samples.

First the selector 730 may receive a set of inputs, represented by the pair {μ, V}, representing the means and covariances of N random variables extracted from the samples of the received dataset. The selector 720 may draws T samples (observations) from the DGP characterized by {μ, V}, and may apply the Monte Carlo algorithm to derive a simulated pair {\hat{μ}, \hat{V}} based on the T samples. The selector 720 may optionally de-noise the simulated covariance matrix \hat{V} to reduce and potentially remove noise which may be included in the input random variables.

The selector 720 may apply M alternative prediction models to compute M respective predicted optimal solutions \hat{ω}* based on the simulated pair {\hat{μ}, \hat{V}} and may record the predicted optimal solutions \hat{ω}* associated with this iteration of the MCOS process 600. The selector 720 may repeat this process for a predefined number of iterations MAX_SIM.

The selector 720 may further compute a true (real) optimal solution a derived from the pair {μ, V}. The selector 720 may then compute the estimation error associated with each of the M alternative prediction models and may select and reports the prediction model presenting the smallest estimation error and hence may yield the most robust optimal solutions \hat{ω}* for the particular set of inputs {μ, V}.

Following is a numerical example demonstrating the enhanced performance, specifically the prediction accuracy of the NCO convex optimization based prediction model compared to a convection optimization (CVO) method as known in the art.

The example is directed to financial investment prediction applications in which the prediction models may be applied to determine a portfolio of financial assets which is predicted to produce (yield) optimal solutions specifically optimal outcomes (return of investment, revenues). However, this should not be construed as limiting since the prediction models may be applied to compute optimal solutions for a plurality of other optimization problems applicable for a plurality of other applications.

Specifically, two characteristic portfolios of the efficient frontier are discussed herein after, namely the minimum variance and maximum Sharpe Ratio solutions, since any member of the unconstrained efficient frontier may be derived as a convex combination of these two portfolios.

An exemplary code presented in code snippet 6 below may be applied to create a random vector of means and a random covariance matrix which represent a stylized version of a 50 securities portfolio, grouped in 10 blocks with intra-cluster correlations of 0.5. This vector and covariance matrix may characterize the “true” process that generates observations {μ, V}. A seed may be set for reproducing results across runs (iterations) with different parameters. In practice, the pair {μ, V} does not need to be simulated, and the selector 720 executing the MCOS process 600 may receive {μ, V} as an input.

### Code Snippet 6:

```
def formTrueMatrix(nBlocks,bSize,bCorr,std0=None):
  corr0=formBlockMatrix(nBlocks,bSize,bCorr)
  corr0=pd.DataFrame(corr0)
  cols=corr0.columns.tolist( )
  np.random.shuffle(cols)
  corr0=corr0[cols].loc[cols].copy(deep=True)
  if std0 is None:std0=np.random.uniform(.05,.2,corr0.shape[0])
  else:std0=np.array([std0]*corr0.shape[1])
  cov0=corr2cov(corr0,std0)
  mu0=np.random.normal(std0,std0,cov0.shape[0]).reshape(−1,1)
  return mu0,cov0
#------------------------------------------------------------------------------
nBlocks,bSize,bCorr =10,50,.5
np.random.seed(0)
mu0,cov0=formTrueMatrix(nBlocks,bSize,bCorr)
```

The function simCovMu may be used to simulate a random empirical vector of means and a random empirical covariance matrix based on 1,000 observations drawn from the true DGP. When shrink=True, the empirical covariance matrix may be shrunk using one or more of the shrinkage procedures, for example, the Ledoit-Wolf shrinkage. Using that empirical covariance matrix, the function optPort may estimate the minimum variance portfolio according to the CVO based prediction model while the function optPort_nco may estimate the minimum variance portfolio for the NCO prediction model. This procedure may be is repeated on 1,000 different random empirical covariance matrices. It should be noted that, because minVarPortf=True, the random empirical vectors of means are discarded. The Monte Carlo algorithm may be executed with and without shrinkage, thus obtaining four combinations displayed in table 1 below which presents the estimation errors for each of the compared prediction models according to the four combinations.

TABLE 1

| | CVO Base | NCO Base |
|---|---|---|
| | Prediction Model | Prediction Model |
| Raw | 7.27E−03 | 3.27E−03 |
| Shrunk (S) | 6.26E−03 | 2.82E−03 |
| De-Noise (D) | 3.20E−03 | 2.65E−03 |
| Shrunk and DE-Noise (S + D) | 7.01E−03 | 2.33E−03 |

As seen from the results in table 1, the raw estimation error of the NCO based prediction model computing the minimum variance portfolio is 44.95% of the raw estimation error of the CVO based prediction model computing the same minimum variance portfolio, i.e. a 55.05% reduction in the estimation error.

While the Ledoit-Wolf shrinkage may reduce the estimation error, that reduction is relatively small for both the NCO based prediction model and the CVO based prediction model, around 13.91%.

Applying the NCO based prediction model with shrinkage may yield a 61.30% reduction in the estimation error of the minimum variance portfolio compared to the CVO based prediction model raw estimation error while applying the NCO based prediction model with de-noising may yield a 63.63% reduction in the estimation error of the minimum variance portfolio compared to the CVO based prediction model raw estimation error.

It should be noted that applying the CVO based prediction model with de-noising may produce an estimation error which is very similar to the NCO based prediction model raw estimation error. However, applying the NCO based prediction model with de-noising dramatically improves the estimation error compared to the CVO based prediction model applied with de-noising, meaning that the benefits of NCO methodology and the de-noising do not perfectly overlap.

As seen in table 1, the largest reduction in the estimation error is achieved when applying the NCO based prediction model with shrinkage and de-noising, a reduction in the order of 68.00%.

Evidently the NCO based prediction model may deliver substantially lower estimation errors compared to the CVO based prediction model solution, even for a small portfolio of only 50 securities. This improvement is further enhanced when combining the NCO based prediction model with de-noising and, to a lesser extent, with shrinkage. It may be fairly straight forward to demonstrate that the advantage of the NCO based prediction model, specifically the reduced estimation error, may be further improved for larger portfolios.

By setting minVarPortf=False, the Monte Carlo algorithm may be applied to derive the estimation errors associated with the maximum Sharpe Ratio portfolio. Results for this experiment are presented in table 2 below.

TABLE 2

| | CVO Based | NCO Based |
|---|---|---|
| | Prediction Model | Prediction Model |
| Raw | 6.34E−02 | 2.67E−02 |
| Shrunk (S) | 3.50E−02 | 1.63E−02 |
| De-Noise (D) | 3.52E−02 | 2.64E−02 |
| Shrunk and DE-Noise (S + D) | 2.04E−02 | 1.50E−02 |

As seen from the results in table 2, the raw estimation error of the NCO based prediction model computing the maximum Sharpe Ratio portfolio is 42.20% of the raw estimation error of the CVO based prediction model computing the same maximum Sharpe Ratio, i.e. a 57.80% reduction in the estimation error.

Applying the NCO based prediction model with shrinkage may yield a 73.34% reduction in the estimation error of the maximum Sharpe Ratio portfolio compared to the CVO based prediction model raw estimation error while applying the NCO based prediction model with de-noising and shrinkage may yield the greatest reduction of 76.31% in the estimation error of the maximum Sharpe Ratio portfolio compared to the CVO based prediction model raw estimation error.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems, methods and computer programs will be developed and the scope of the terms convex optimization algorithms, prediction models, ML models and neural networks are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A computer implemented method of improving the accuracy while reducing the computation load of convex optimization-based prediction models, comprising:
using at least one processor for:
receiving a distribution of expected values of a plurality of random variables extracted from a plurality of samples and a covariance matrix of the plurality of random variables;
clustering the plurality of random variables to a plurality of clusters based on the covariance matrix such that each of the plurality clusters comprising a respective subset of highly codependent expected values;
applying a convex optimization based prediction model to compute predicted optimal intra-cluster solutions for each of the plurality of clusters;
collapsing the covariance matrix, based on the optimal intra-cluster solutions, to a reduced covariance matrix in which each of the plurality of clusters is represented as a single variable;
applying the convex optimization based prediction model to compute a predicted optimal inter-cluster solution over the reduced covariance matrix; and
predicting optimal solutions for the plurality of samples based on a plurality of dot products computed between the optimal intra-cluster solutions and the optimal inter-cluster solution;
wherein splitting the prediction to separately compute the predicted optimal intra-cluster solutions and the predicted optimal inter-cluster solution reduces a computation load of the convex optimization based prediction model.

2. The method of claim 1, further comprising applying at least one de-noising function to reduce a noise in at least some of the plurality of random variables.

3. The method of claim 2, wherein the at least one de-noising function is based on identifying noise components and signal components in each of at least some of the plurality of random variables, the noise components and the signal components are identified by their corresponding eigenvalues computed for the received covariance matrix.

4. The method of claim 1, wherein clustering the plurality of values to the plurality of clusters is done using at least one Machine Learning (ML) model applied to the covariance matrix.

5. The method of claim 1, wherein the convex optimization based prediction model is applied to determine an allocation of an investment in a plurality of financial assets predicted to produce optimal outcomes.

6. A system for reducing a computation load of convex optimization based prediction models, comprising:
at least one processor executing a code, the code comprising:
code instructions to receive a distribution of expected values of a plurality of random variables extracted from a plurality of samples and a covariance matrix of the plurality of random variables;
code instructions to cluster the plurality of random variables to a plurality of clusters based on the covariance matrix such that each of the plurality clusters comprising a respective subset of highly codependent random variables;
code instructions to apply a convex optimization based prediction model to compute predicted optimal intra-cluster solutions for each of the plurality of clusters;
code instructions to collapse the covariance matrix, based on the optimal intra-cluster solutions, to a reduced covariance matrix in which each of the plurality of clusters is represented as a single variable;
code instructions to apply the convex optimization based prediction model to compute a predicted optimal inter-cluster solution over the reduced covariance matrix; and
code instructions to predict optimal solutions for the plurality of samples based on a plurality of dot products computed between the optimal intra-cluster solutions and the optimal inter-cluster solution;
wherein splitting the prediction to separately compute the predicted optimal intra-cluster solutions and the predicted optimal inter-cluster solution reduces a computation load of the convex optimization based prediction model.

7. A computer program product comprising program instructions executable by a computer, which, when executed by the computer, cause the computer to perform a method according to claim 1.

8. A computer implemented method of selecting a best performing prediction model for a certain dataset of samples, comprising:
receiving a distribution of expected values of a plurality of random variables extracted from a plurality of samples and a covariance matrix of the plurality of random variables;
applying a Monte Carlo algorithm which generates a plurality of simulated expected values and a plurality of simulated covariance matrices based on a user-defined Data Generating Process (DGP) characterized by the received distribution and covariance matrix;
applying a plurality of prediction models configured to compute, based on the plurality of simulated expected values and the plurality of simulated covariance matrices, a plurality of respective predicted optimal solutions;
computing an estimation error for each of the plurality of prediction models based on a comparison between the respective predicted optimal solution computed by the respective prediction model and a real optimal solution derived from the user-defined DGP; and
selecting a preferred prediction model whose predicted optimal solution presents a smallest estimation error, wherein the preferred optimizations model is used to predict optimal solutions for the plurality of samples.

9. The method of claim 8, further comprising applying at least one de-noising function to reduce a noise in at least some of the plurality of random variables.

10. The method of claim 8, further comprising repeating a plurality of iterations of the steps of applying the Monte Carlo algorithm, and selecting a preferred prediction model whose prediction set presents the smallest estimation error, wherein in each of the plurality of iterations the Monte Carlo algorithm generates another set of a plurality of simulated expected values and a plurality of simulated covariance matrices based on the user-defined DGP.

11. The method of claim 8, wherein the plurality of prediction models are applied to determine an allocation of an investment in a plurality of financial assets predicted to produce optimal outcomes.

12. A system for selecting a best performing prediction model for a certain dataset of samples, comprising:
at least one processor executing a code, the code comprising:
code instructions to receive a distribution of expected values of a plurality of random variables extracted from a plurality of samples and a covariance matrix of the same random variable;
code instructions to apply a Monte Carlo algorithm that generates a plurality of simulated expected values and a plurality of simulated covariance matrices based on a user-defined Data Generating Process (DGP) characterized by the received distribution and covariance matrix;
code instructions to apply a plurality of prediction models configured to compute, based on the plurality of simulated expected values and the plurality of simulated covariance matrices, a plurality of respective predicted optimal solutions;
code instructions to compute an estimation error for each of the plurality of prediction models based on a comparison between the respective predicted optimal solution computed by the respective prediction model and a real optimal solution derived from the user-defined DGP; and
code instructions to select a preferred prediction model whose predicted optimal solution presents a smallest estimation error, wherein the preferred optimizations model is used to predict optimal solutions for the plurality of samples.

13. A computer program product comprising program instructions executable by a computer, which, when executed by the computer, cause the computer to perform a method according to claim 8.
